(19) United States
(12) Patent Application Publication
(10) Pub. No.: US 2006/0016167 A1
(43) Pub. Date: Jan. 26, 2006

(54) Lawn vacuum

(75) Inventor: Jason Mathew Banowetz, Glenside, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Shiller-Pfeiffer, Inc.

(21) Appl. No.: 11/185,176

(22) Filed: Jul. 20, 2005

Related U.S. Application Data
(60) Provisional application No. 60/589,271, filed on Jul. 20, 2004.

(51) Int. Cl. A01D 43/02

(52) U.S. Cl. 56/344

(57) ABSTRACT

A lawn vacuum for removing debris from a ground surface and storing the debris including a frame, a nozzle defining an inlet and an impeller that is in communication with the nozzle to create a vacuum pressure at the inlet. A discharge adapter includes a first end mounted to an outlet end of the impeller and a discharge end. A bag assembly includes a bag, a sleeve and a lid. The discharge end of the discharge adapter is mounted to dispense debris from the impeller into a chamber. The sleeve has a generally cylindrical shape and includes a first mouth and a second mouth. The bag includes an open top end and a closed bottom end and is mounted at its top end to the first mouth such that the bag is at least partially encompassed by the sleeve to guide air toward the second mouth.

### CROSS-REFERENCE TO RELATED APPLICATIONS

This application claims the benefit of U.S. Provisional Patent Application No. 60/589,271, filed Jul. 20, 2004.

### BACKGROUND OF THE INVENTION

The present invention relates generally to devices used to collect debris and, more particularly, to a lawn vacuum used to collect debris, such as grass and leaves.

Vacuum devices for collecting debris such as grass clippings and leaves are known in the art. One conventional lawn vacuum comprises a collector which can be mounted on the rear of a riding mower. Such systems generally include a blower or vacuum system that draws clippings from a discharge port in the mower deck to the collector. Other collection systems include push mowers with bags mounted at the rear or side of the mower. Such systems typically utilize the driving force of the lawn mower blades to propel the grass cuttings and debris into the bag.

Lawn vacuums without mowers have also been developed. Such vacuums often include a nozzle at the front end operatively associated with a motor driven impeller and a collection bag. A deficiency of the prior lawn vacuums becomes evident when the user attempts to vacuum over an obstacle on the surface of the ground. The nozzle height of some lawn vacuums is rigidly set at a certain height, forcing a user to manually tilt the lawn vacuum upwardly to overcome the obstacle if the obstacle were to extend above the nozzle height. Some nozzles are pivotably mounted and include wheels to ride over large obstacles. However, the wheels are mounted behind the nozzle creating problems in that the nozzle does not react quickly enough to debris or large obstacles.

Collection assemblies within lawn mowers that utilize cyclonic motion are also known. Lawn mowers that utilize cyclonic motion within the collection assembly are used in conjunction with a solid housing. The solid housings typically include openings at or near the top of the assembly for air to escape. This results in lack of downward air circulation within the assembly and debris generally does not fill the assembly to its maximum capacity. Thus, the solid housing hinders downward airflow and premature replacement of the collection assembly results. In addition, the outlet is located at a chest or head height of a user where air or other debris flows out of the outlet. Such an outlet height irritating and potentially dangerous to a user and bystanders.

A need exists, therefore, for a lawn vacuum which easily traverses large debris without user intervention. In addition, a need exists for a collection assembly capable of efficient collection of debris that deflects debris into a collection area away from a user and directs outlet air and debris away from the user and any bystanders.

### BRIEF SUMMARY OF THE INVENTION

Briefly stated, a preferred embodiment of the present invention is directed to a lawn vacuum for removing debris from a ground surface and storing the debris for disposal. The lawn vacuum includes a frame, a nozzle defining an inlet mounted to the frame and an impeller in communication with the nozzle through a tube to create a vacuum pressure at the inlet for drawing the debris into the nozzle. A discharge adapter includes a first end and a discharge end. The first end is mounted to an outlet end of the impeller for carrying the debris away from the impeller. A bag assembly includes a bag, a sleeve and a lid. The discharge end of the discharge adapter is mounted to dispense debris from the impeller into a chamber defined by the bag assembly. The sleeve is generally air impervious and has a generally cylindrical shape. The sleeve includes a first mouth and a second mouth and the bag includes an open top end and a closed bottom end. The bag is mounted at its top end to the first mouth of the sleeve such that the bag is at least partially encompassed by the sleeve such that the sleeve generally guides air entering the bag assembly toward the second mouth.

In another aspect, a preferred embodiment of the present invention is directed to a lawn vacuum for removing debris from a ground surface and storing the debris for disposal. The lawn vacuum includes a frame, a nozzle mounted to the frame and defining an inlet and an impeller mounted to the frame for creating a vacuum pressure at the inlet to draw debris into the inlet. A bag assembly includes a lid and a container in communication with the impeller. The lid includes a top wall, a generally cylindrical flange and an inner cylinder. The flange and inner cylinder define a debris deflection area for deflecting debris drawn into the container by the impeller.

### BRIEF DESCRIPTION OF THE SEVERAL VIEWS OF THE DRAWINGS

The foregoing summary, as well as the following detailed description of preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a is a side elevation view of a lawn vacuum in accordance with a preferred embodiment of the present invention;

FIG. 2 is a front elevation view of the lawn vacuum of FIG. 1;

FIG. 3 is a top plan view of the lawn vacuum of FIG. 1;

FIG. 4 is a partial cross-sectional view of the lawn vacuum of FIG. 3 taken along line 4-4 of FIG. 3;

FIG. 5 is an enlarged cross-sectional view of the lawn vacuum bag assembly of FIG. 4 taken along line 5-5 of FIG. 4;

FIG. 6 is a side elevation view of the lawn vacuum bag assembly of FIG. 5 taken along line 6-6 of FIG. 5;

FIG. 7 is a cross-sectional side view of the lawn vacuum bag assembly of FIG. 5 taken along line 7-7 of FIG. 5;

FIG. 8 is a fragmentary view of a channel of the collection bag assembly of FIG. 7; and

FIG. 9 is a greatly enlarged cross-sectional view of a buckle portion of the collection bag assembly of FIG. 7 taken along line 9-9 of FIG. 7.

### DETAILED DESCRIPTION OF THE INVENTION

Certain terminology is used in the following description for convenience only and is not limiting. The words “right”, “left”, “upper” and “lower” designate directions in the drawings to which reference is made. The words “inwardly” and “outwardly” refer to directions toward and away from, respectively, the geometric center of the lawn vacuum and designated parts thereof. The word “a” is defined to mean “at least one”. The terminology includes the words above specifically mentioned, derivatives thereof, and words of similar import.

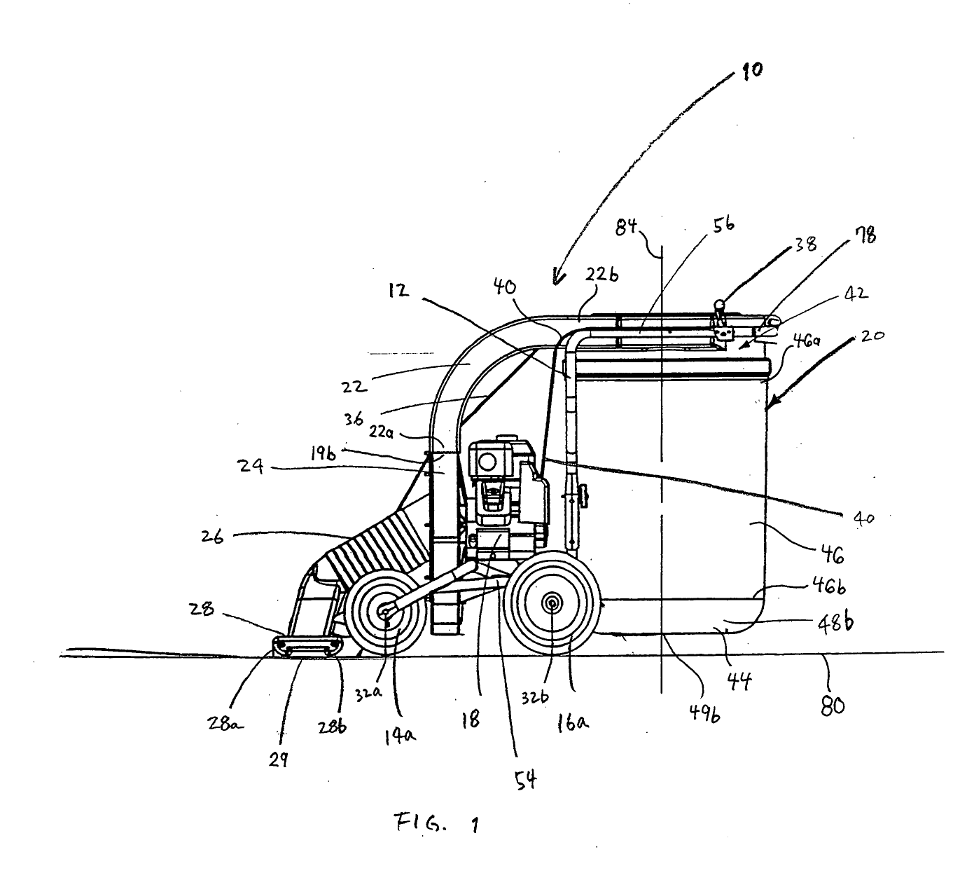

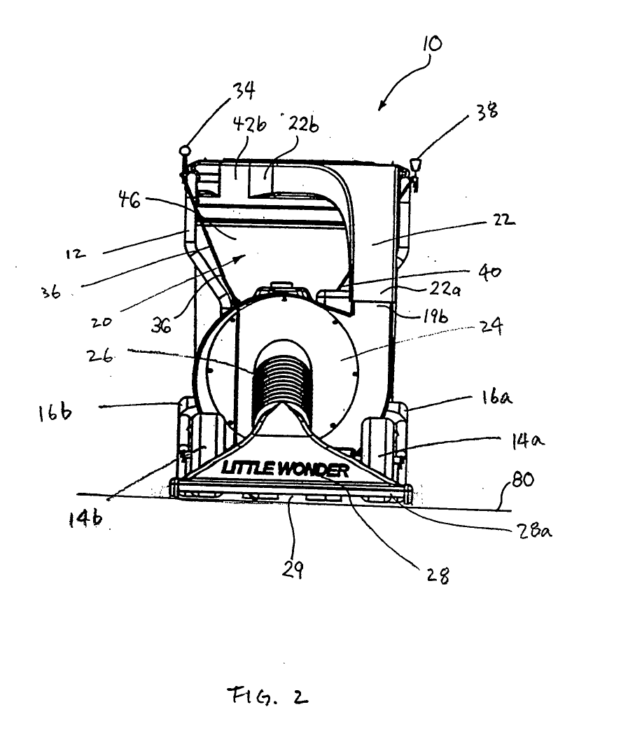

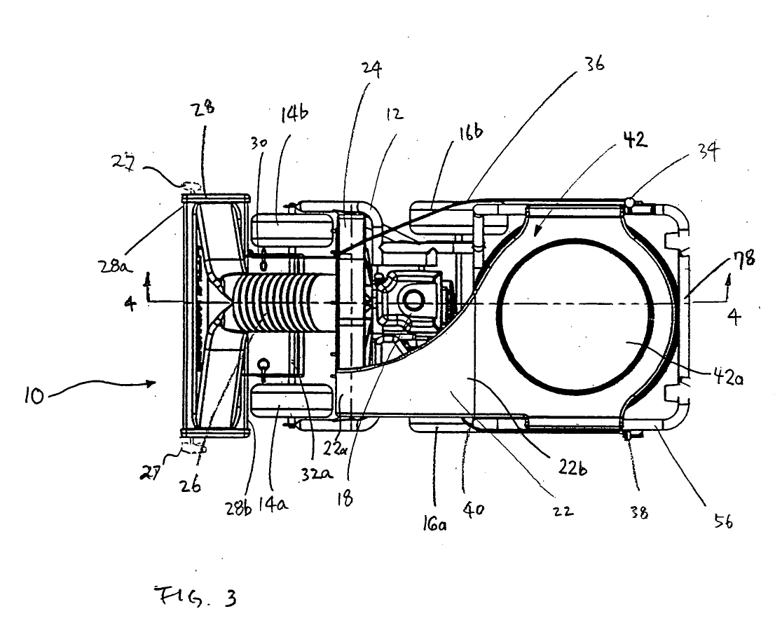

Referring to the drawings in detail, wherein like numerals indicate like elements throughout the figures, there is shown in FIGS. 1-4, a preferred lawn vacuum, generally designated 10, which is used to gather or remove debris such as grass and leaves from a ground surface 80 and storing the debris for disposal. The lawn vacuum 10 includes a frame 12 supported by wheels 14a, 14b, 16a, 16b. The frame 12 supports a collection bag assembly 20 and an engine 18 that is connected to an impeller 19. Furthermore, a nozzle 28 extends from a flexible tube 26 that is operatively connected to the impeller 19. The engine 18, impeller 19, nozzle 28 and wheels 14a, 14b, 16a, 16b are preferably mounted to the frame 12.

Referring to FIGS. 1-4, the frame 12 supports a front axle 32a and a rear axle 32b which rotatably support the two front wheels 14a, 14b and two rear wheels 16a, 16b, respectively. In the preferred embodiment, the frame 12 is constructed from a series of interconnected tubes which form a double L-shape and is preferably made of a light weight high strength material, such as steel or aluminum. The frame 12 includes a handle 78 extending, across the rear of the lawn vacuum 10. From this disclosure, one of ordinary skill in the art would recognize that the frame 12 could be made from other materials, such as plastics or composite materials. Furthermore, one of ordinary skill in the art would recognize that the frame 12 could be one continuous piece and the shape of the frame 12 could be constructed in any manner so long as it could support the necessary components and withstand the normal operating conditions of the lawn vacuum 10, as is described below.

The engine 18 is preferably secured to a platform or lower portion 54 of the frame 12. A throttle control 38 is located on the handle 78 on an upper portion 56 of the frame 12 and controls the speed of the engine 18 via a cable 40. In the preferred embodiment, the engine 18 is a gasoline engine. Engines for operating lawn vacuums are well known to those of ordinary skill in the art. Accordingly, further description of the engine 18 is omitted for purposes of convenience only and is not limiting.

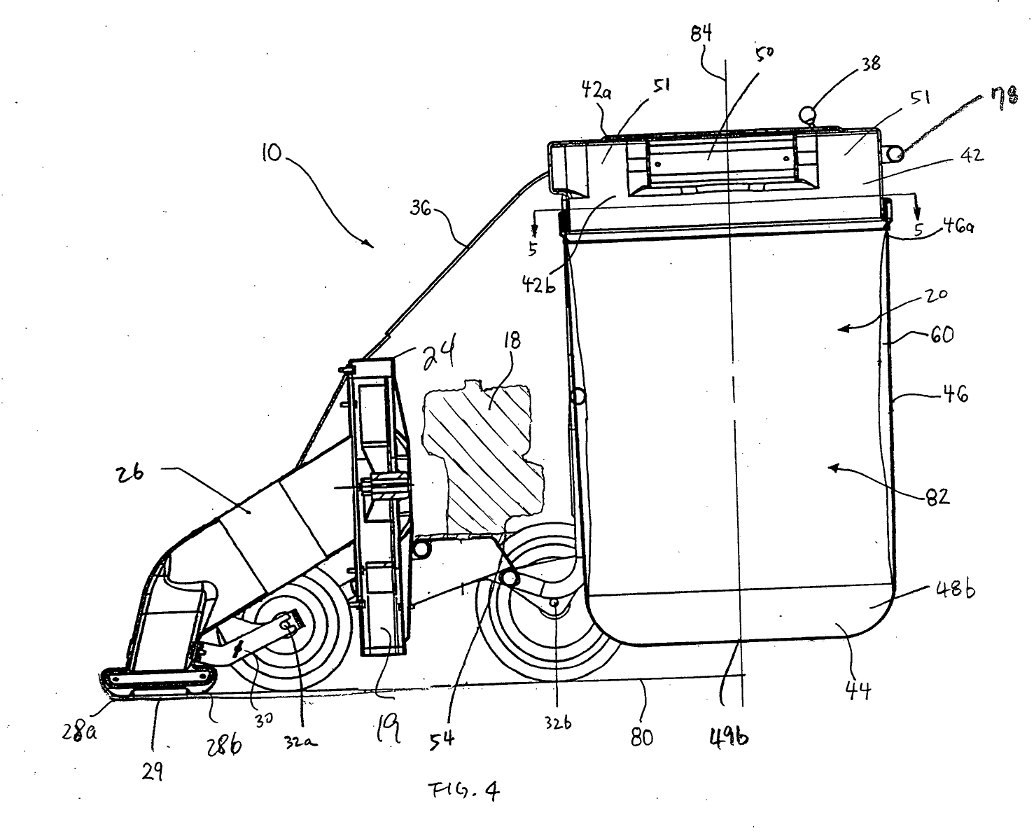

Referring to FIGS. 1 and 4, the impeller 19 is attached to and powered by the engine 18 and is enclosed by a housing assembly 24. The housing assembly 24 is operably connected to a discharge adapter 22 on one end and a tube 26 on an opposite end. The tube 26 is preferably constructed with a flexible material, such as soft plastic such that the nozzle 28 is able to move relative to the frame 12, as will be described in greater detail below. In the preferred embodiment, the housing assembly 24, impeller 19 and discharge adapter 22 are constructed of a sturdy material, such as steel or aluminum. One of ordinary skill in the art would recognize that other materials, such as plastics or composite materials, could be substituted without departing from the spirit and scope of the invention.

The nozzle 28 is operably connected to the distal end of the flexible tube 26 and extends down to the ground surface 80. The nozzle 28 defines an inlet 29 that is preferably facing the ground surface 80 in the working position and opens into a hollow of the flexible tube 26. The nozzle 28 preferably has curved ends 28a, 28b and is pivotally supported by a front bracket 30 that pivots about the front axle 32a. In the preferred embodiment, the front bracket 30 is pivotally mounted to the front axle 32a between the two front wheels 14a, 14b and is mounted to an inner surface of the nozzle 28. The front bracket 30 is preferably connected to a nozzle height control 34 located on the handle 78. The nozzle height control 34 preferably permits a user to modify the height of the nozzle 28 relative to the ground surface 80 by manipulating a cable 36. The flexible tube 26 and front bracket 30 permit the nozzle 28 to pivot about the front axle 32a for modification of the height of the nozzle 28 and inlet 29 relative to the ground surface 80. It may be advantageous to modify the height of the nozzle 28 relative to the ground surface 80 depending upon the amount of size of debris being encountered by the lawn vacuum 10 or the roughness of the ground surface 80 itself, as will be understood by one having ordinary skill in the art. For example, if the lawn vacuum 10 is going to encounter a relatively tall piece of debris, the user may raise the nozzle 28 and inlet 29 relative to the ground surface 80 such that the debris moves under the inlet 29 as the lawn vacuum 10 travels toward and over the debris.

The impeller 19 is in communication with the nozzle 28 through the tube 26 such that a vacuum pressure may be created at the inlet 29 for drawing debris into the nozzle. Accordingly, when the nozzle 28 and inlet 29 are positioned over a piece of debris, the vacuum pressure at the inlet 29 draws the debris into the inlet 29 and into the tube 26.

The preferred nozzle 28 may include nozzle wheels 27 (shown in phantom) rotatably attached to the lateral ends of the nozzle 28 or the nozzle wheels 27 may be built into the ends of the nozzle 28 such that only a bottom portion of the wheels 27 is visible in a plan view. Using wheels 27 on the front end of the nozzle 28 allows the nozzle 28 to navigate over debris in the path of the lawn vacuum 10. One having ordinary skill in the art will realize that the nozzle wheels 27 are not required for the operation of the lawn vacuum 10 and may be completely eliminated from the device, without severely impacting the overall operation of the lawn vacuum 10.

Referring to FIGS. 1-3, the discharge adapter 22 includes a first end 22a and a discharge end 22b. The first end 22a is mounted to an outlet end 19b of the impeller 19 for carrying debris away from the impeller 19. The discharge adapter 22 is preferably constructed of a generally rigid structural material that is able to withstand the normal operating conditions of the lawn vacuum 10. For example, the discharge adapter 22 may be constructed of an aluminum, steel, polymeric or composite material that is able to take on the general shape and size of the discharge adapter 22. In addition, the first end 22a is preferably adaptable to the outlet end 19b of the impeller 19 such that debris driven by the impeller 19 exiting the outlet end 19b is received into the first end 22a.

Referring to FIGS. 1, 3 and 4, the frame upper portion 56 supports the collection bag assembly 20, which includes a lid 42 that is preferably rigidly attached to the frame upper portion 56, a debris bag 44 and a sleeve 46. The discharge end 22b of the discharge adapter 22 is mounted to the bag assembly 20 to dispense the debris into a storage chamber 82 defined by the bag assembly 20. The sleeve 46 is preferably constructed of an air impervious material, has a generally cylindrical shape and includes a first mouth 46a and a second mouth 46b. In the preferred embodiment, the sleeve 46 is constructed of a polymeric material and, more specifically, a synthetic rubber material. The synthetic rubber material is preferred for the construction of the sleeve 46 due to its toughness, formability and relatively light weight. However, one having ordinary skill in the art will realize that the sleeve is not limited to being constructed of a polymeric material or to the synthetic rubber material and may be constructed of nearly any material that is able to take on the general shape of the sleeve and withstand the normal operating conditions of the lawn vacuum 10.

The lid 42 preferably has a substantially circular or disc-like shape and is preferably constructed of a solid material. The lid 42 preferably includes a top wall 42a, an inner cylinder 50 that extends generally perpendicularly from the top wall 42a toward the bag 44 in a working configuration and a generally cylindrical flange 42b that extends generally perpendicularly from the top wall 42a toward the bag 44 in the working configuration. The inner cylinder 50 and cylindrical flange 42b define an annular debris deflection area 51 into which debris flows as the debris exits the discharge end 22b of the discharge adapter 22. In the preferred embodiment, the lid 42 and the inner cylinder 50 are constructed of a generally rigid polymeric material and, specifically, a plastic material. One of ordinary skill in the art would recognize that other rigid materials could be substituted for the construction of the lid 42, such as steel or composite materials. Furthermore, one of ordinary skill in the art would recognize that the lid 42 may be constructed in other various shapes. In the preferred embodiment, as the debris and air enters the annular debris deflection area 51, the debris and air are deflected by surfaces of the inner cylinder 50 and flange 42b to rotate around the deflection area 51 and downwardly toward the bottom of the bag assembly 20, as is described in greater detail below.

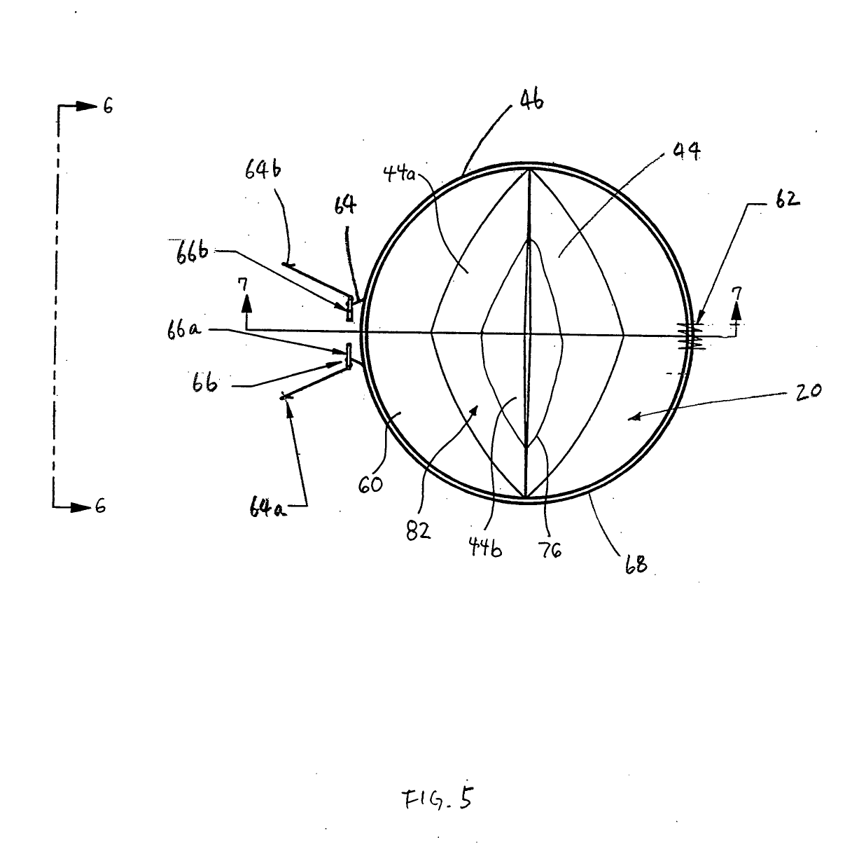

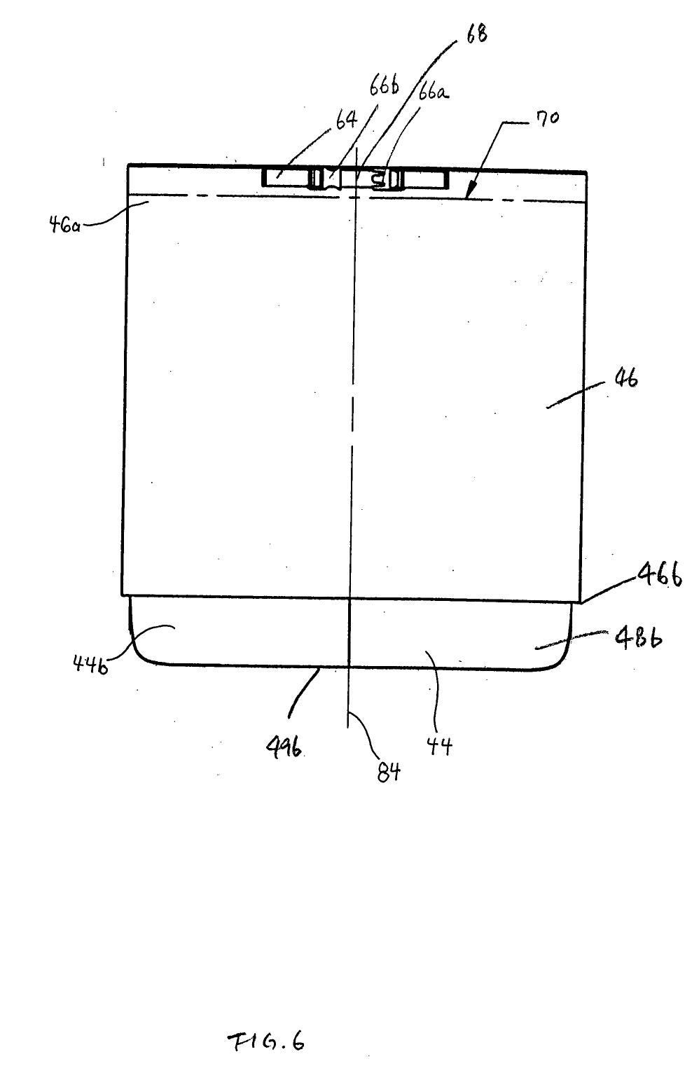

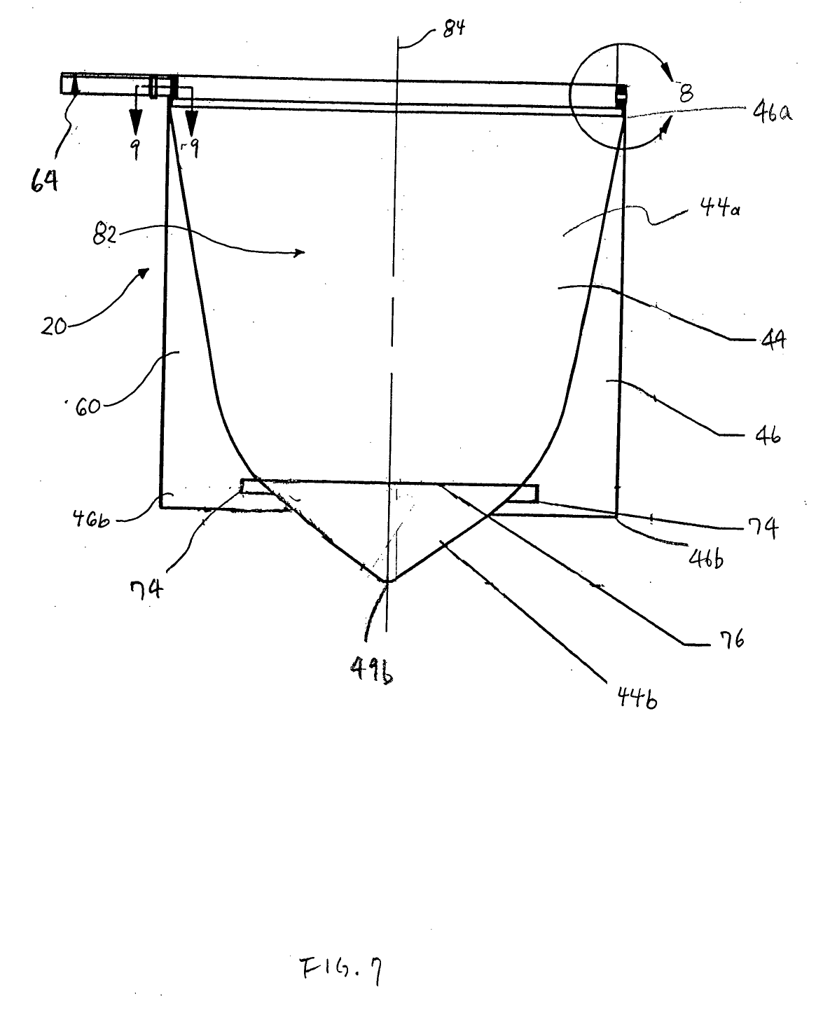

Referring to FIGS. 5-7, the debris bag 44 is shaped similar to a tea bag (see FIG. 7) in the preferred embodiment and includes a top portion 44a and a bottom portion 44b which are mechanically secured by stitching at an intersection line 76. In the preferred embodiment, the top portion 44a is constructed of a mesh fabric and the bottom portion 44b is constructed of an air impervious material, most preferably, ballistic nylon. The mesh fabric is preferably made from polyester or polypropylene. The debris bag 44 is open at a top end 49a of the top portion 44a and closed at a bottom end 49b of the bottom portion 44b. One of ordinary skill in the art will recognize that the debris bag 44 may take on nearly any shape and utilize numerous additional materials as long as the bag 44 is able to withstand the normal operating conditions of the lawn vacuum 10 and perform the normal functions of the bag 44 during operation of the lawn vacuum 10. The bag 44 is preferably mounted at its top end 49a to the first mouth 46a of the sleeve 46 such that the bag 44 is at least partially encompassed by the sleeve 46 and such that the sleeve 46 generally guides air entering the bag assembly 20 toward the second mouth 46b. In the preferred embodiment, based upon the configuration of the bag assembly 20 and the orientation of the discharge end 22b relative to the deflection area 51, the air and debris are urged into the bag 44 in a generally downward circular path toward the second mouth 46b. The debris is generally captured in the chamber 82, which is defined by the bag 44, and the air exits the bag assembly 20 through the second mouth 46b, which is preferably close to the ground surface 80, resulting in the forced air being directed away from a head and chest area of a user and any bystanders.

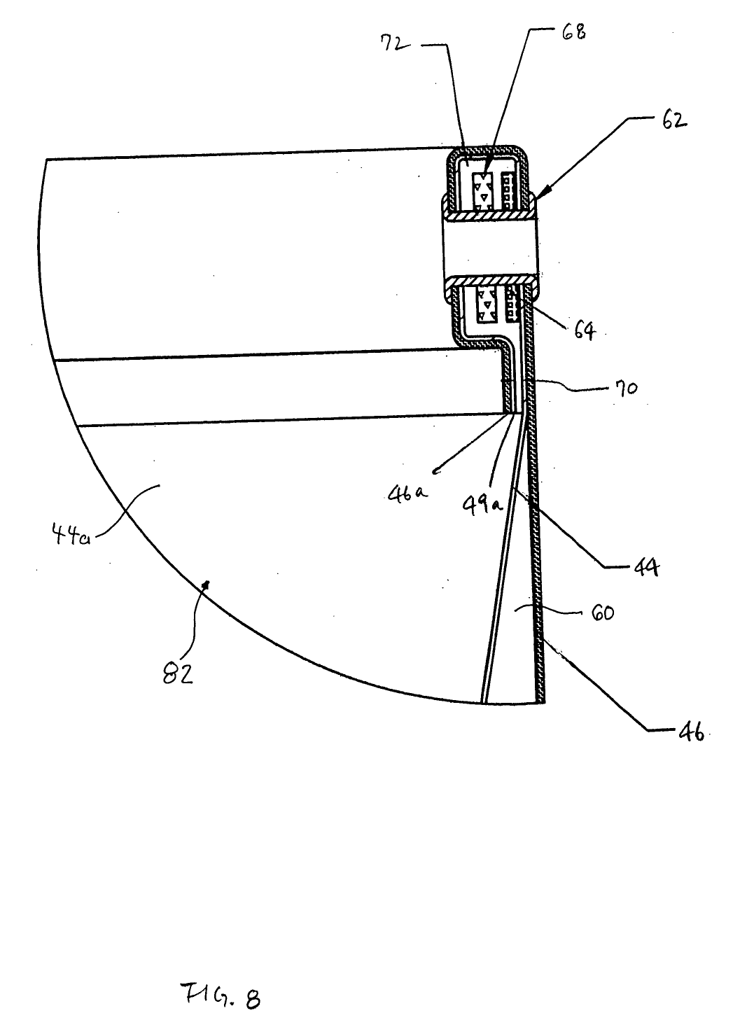

Referring to FIGS. 7 and 8, the top portion 44a is preferably attached to the lid 42 and is substantially surrounded at its sides by the air impervious sleeve 46. In the preferred embodiment, the sleeve 46 is cylindrical in shape and is constructed of synthetic rubber. One of ordinary skill in the art would recognize that the sleeve 46 could take on other shapes and alternate materials could be substituted. The sleeve 46 is preferably hollow and open on both ends prior to attachment to the debris bag 44. The top end 49a of the debris bag 44 is preferably layered or overlaps with the first mouth 46a of the sleeve 46. The first mouth 46a and top end 49a are then folded inwardly onto themselves to form a channel 72. In the preferred embodiment, the first mouth 46a and top end 49a are stitched or sewed together to form a seam 70. One of ordinary skill in the art would recognize that other forms of mechanical attachments such as riveting, adhesively fastening, bolting or clipping could be used without departing from the spirit and scope of the invention.

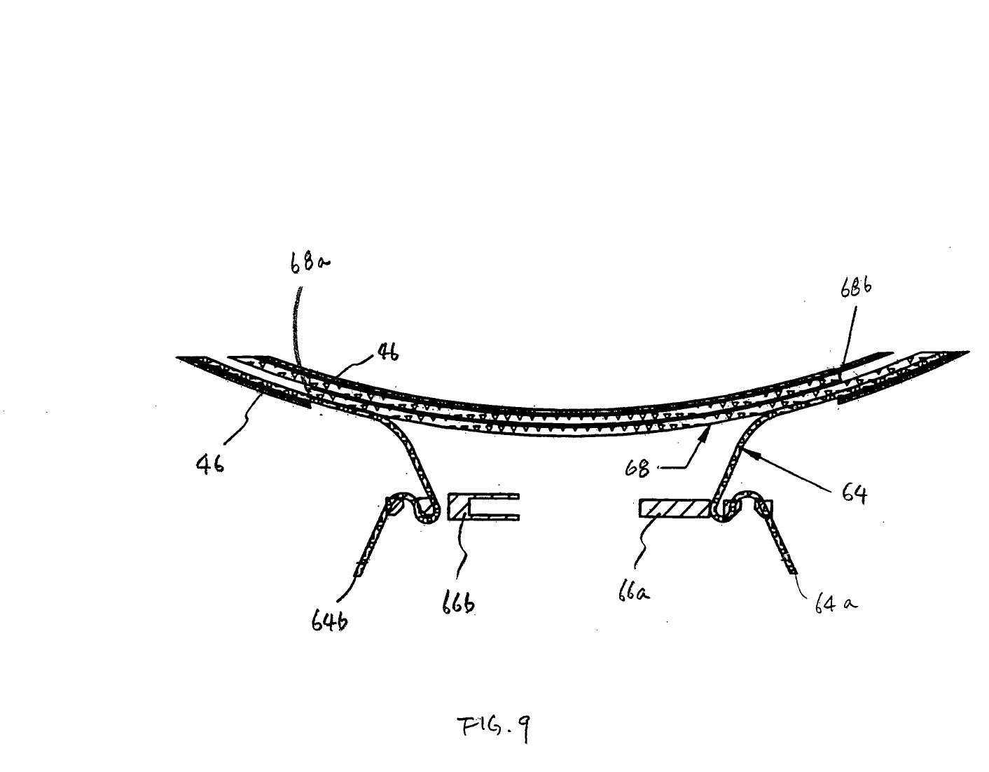

Referring to FIGS. 5-9, the debris bag 44 and the sleeve 46 are preferably, mechanically secured to the lid 42. A semi-rigid band 68 having a first end 68a and a second end 68b is located within the channel 72 and snugly fits over the outer circumference of the lid 42. The band 68 is substantially greater in length than the circumference of the lid 42 such that the band 68 overlaps at or near a quick connect device 66. A strap 64 having a first end 64a and a second end 64b is secured on top of the band 68 and within the channel 72. In the preferred embodiment, the band 68 is constructed of nylon and the strap 64 is constructed of polypropylene webbing. One with ordinary skill in the art would recognize that other materials that are able to withstand the stresses encountered by the band 68 and strap 64 could be substituted. In addition, one having ordinary skill in the art will realize that the bag 44 and sleeve 46 may be mounted to or secured to the lid 42 in numerous alternative arrangement, for example, by clamping, mechanical fastening, adhesive bonding, welding or other like securing arrangements

A male portion 66a of a quick connect device 66 is preferably attached at or near the first end 64a of the strap and a female portion 66b is attached at or near the second end 64b of the strap 64. One of ordinary skill in the art would recognize that other forms of quick connect devices could be used, such as hook and loop material. The debris bag 44, sleeve 46, band 68 and strap 64 are further anchored to each other by a grommet 62 at a point opposite the quick connect device 66. In the preferred embodiment, the grommet 62 is a rivet. Again, one of ordinary skill in the art would recognize that other forms of securing could be substituted such as stitching, adhesively fastening, bolting or clipping without departing from the spirit and scope of the invention.

Referring to FIG. 7, the debris bag 44 further includes bag handles 74 located at or near the intersection line 76 of the top portion 44a and the bottom portion 44b. In the preferred embodiment, the handles 74 are constructed of polypropylene webbing but one of ordinary skill in the art would recognize that other materials such as cotton or nylon could be substituted without departing from the spirit and scope of the invention. The handles 74 are used for emptying the debris bag 44.

Referring to FIGS. 1, 4 and 6, the bag 44 typically hangs within the sleeve 46 such that the bottom portion 44b extends beyond the second mouth 46b of the sleeve 46. The ballistic nylon of the bottom portion 44b permits dragging of the bottom portion 44b on the ground surface 80 during use, typically without significantly damaging the bag 44. As will be understood by one having ordinary skill in the art, the bottom portion 44b does not necessarily drag on the ground surface 80 during use and does not necessarily extend beyond the second mouth 46b in the assembled configuration of the bag assembly 20. For example, the bottom portion 44b may be located above the second mouth 46b in the assembled configuration and may be constructed of a mesh material that permits airflow therethrough. However, the ballistic nylon material and extension of the bottom end 49b beyond the second mouth 46b is preferred to maximize the capacity of the chamber 82 and to provide toughness to the bag 44, respectively.

Referring to FIGS. 1, 4, 6 and 7, in the preferred embodiment, the cylindrical flange 42b and the inner cylinder 50 of the lid 42 are mounted coaxially on a central axis 84 of the bag assembly 20. The flange 42b and inner cylinder 50 are preferably mounted coaxially on the central axis 84 to define a generally symmetrical ring-shaped or cylindrical deflection area 51 to create the downward cylindrical flow pattern of the air and debris in the deflection area 51. The flange 42b and inner cylinder 50 are also preferably integrally formed with the top wall 42a during construction of the lid 42.

Referring to FIGS. 4, 5, 7 and 8, in the preferred embodiment, a gap 60 is defined between the sleeve 46 and the bag 44 in the assembled configuration. Due to the mesh construction of the top portion 44a and the air impervious construction of the sleeve 46 and the bottom portion 44b, the air flowing out of the deflection area 51 escapes from the bag assembly 20 by flowing through the mesh top portion 44a, through the gap 60 and out of the second mouth 46b.

In operation, the collection bag assembly 20 of the lawn vacuum 10 is assembled by securing the debris bag 44 and the sleeve 46 to the lid 42. The channel 72 of the top portion 48 is wrapped around the outer circumference of the lid 42 and is secured by the band 68 by overlapping the first end 68a and the second end 68b. The debris bag 44 and sleeve 46 are further secured to the lid 42 by securing the strap 64 within the channel 72 over the band 68 and pulling each end of the strap 64a, 64b. This also tightens the band 68 and forms a snug fit. Once the strap 64 is tightened the male portion 66a and the female portion 66b of the buckle 66 are adjusted and attached to each other to form a tight fit around the flange 42b of the lid 42.

The lawn vacuum 10 is started by engaging the engine 18, which drives the impeller 19. The speed of the engine 18 is controlled with the throttle control 38. The initial height of the nozzle 28 is set by adjusting the nozzle height control 34 to a desired minimum height position above the ground surface 80. As the user moves the lawn vacuum 10 to pick up debris, the impeller 19 creates the vacuum at the inlet 29 and air and debris flow from the nozzle 28 to the collection bag assembly 20 through the nozzle 28, tube 26, housing 24 and discharge adapter 22. When the debris and air, traveling at a high rate of speed, flow through the discharge end 22b and enter the debris deflection area 51, the debris makes initial contact with the top wall 42a, flange 42b and inner cylinder 50 to slow down the speed of the debris. Accordingly, the debris and air are contained in the deflection area 51, which due to its cylindrical shape and the orientation of the discharge end 22b urges the air and debris to flow in a cylindrical and downward path. The flange 42b, top wall 42a and inner cylinder 50 generally prevent the debris bag 44 from tearing or puncturing due to the debris initially impacting these generally rigid and tough components. Therefore, hard debris or sharp objects that enter the collection bag assembly 20 at a high rate of speed generally do not puncture the bag 44 or sleeve 46 because the debris and/or objects generally do not impact the bag 44 or sleeve 46 at high speed. The debris is then forced into a circular path by the solid inner cylinder 50 and lid 42. The debris then travels to the bottom portion 44b in a cyclonic motion. Although the air within the collection bag assembly 20 exits at all points of the debris bag 44, the majority of the air exits the collection bag assembly 20 near the bottom portion 46b of the sleeve 46 because the cyclonic motion of the air is maintained by the air impervious sleeve 46 which forces the air downwardly. The debris is then pushed downwardly by gravity and remains at the bottom portion 44b of the debris bag 44 under the urging of additional air and debris that enters the bag 44 through the discharge end 22b. The weight of the debris within the debris bag 44 may cause the bag 44 to sag and drag against the ground surface 80. The wear resistant fabric or ballistic nylon material of the bottom portion 44b preferably prevents the debris bag 44 from puncturing or tearing. Further, due to this flow pattern, the user does not feel the air blowing on his/her body, specifically in the head and chest area, while the lawn vacuum 10 is moved and is also safe from hard flying objects. Bystanders are also typically protected from coming into contact with the high speed stream of air and/or debris due to this flow pattern.

While the lawn vacuum 10 is being pushed over terrain, it may encounter uneven ground. When the nozzle 28 makes contact with a bump in the ground, the curved ends 28a, 28b of the front end 28 acts as a cam to allow the nozzle 28 to continue to move in a forward direction while pivoting upwardly. The flexible tube 26 allows the nozzle 28 to pivot upwardly while still typically maintaining contact with the ground surface 80. The front bracket 30 guides the nozzle 28 through the pivotal motion. When the user encounters an obstacle too large for the nozzle 28 to surpass, the nozzle height control 34 located near the handle 78 is remotely controlled for quick height adjustment.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the appended claims.

I claim:

1. A lawn vacuum for removing debris from a ground surface and storing the debris for disposal, the lawn vacuum comprising:
a frame;
a nozzle mounted to the frame, the nozzle defining an inlet;
an impeller in communication with the nozzle through a tube to create a vacuum pressure at the inlet for drawing the debris into the nozzle;
a discharge adapter including a first end and a discharge end, the first end mounted to an outlet end of the impeller for carrying the debris away from the impeller
a bag assembly including a bag, a sleeve and a lid, the discharge end of the discharge adapter mounted to dispense debris from the impeller into a chamber defined by the bag assembly, the sleeve being generally air impervious and having a generally cylindrical shape, the sleeve including a first mouth and a second mouth, the bag including an open top end and a closed bottom end, the bag mounted at its top end to the first mouth of the sleeve such that the bag is at least partially encompassed by the sleeve such that the sleeve generally guides air entering the bag assembly toward the second mouth.

2. The lawn vacuum of claim 1 wherein the sleeve is constructed of a polymeric material.

3. The lawn vacuum of claim 2 wherein the sleeve is constructed of a synthetic rubber material.

4. The lawn vacuum of claim 1 wherein the closed bottom of the bag extends beyond the second mouth of the sleeve.

5. The lawn vacuum of claim 4 wherein the bag includes a top portion and a bottom portion, the top portion being constructed of a mesh fabric and the bottom portion being constructed of an air impervious material.

6. The lawn vacuum of claim 5 wherein the air impervious material is a ballistic nylon, the bottom portion being able to rest upon and drag along the ground surface during operation of the lawn vacuum.

7. The lawn vacuum of claim 1 wherein the lid is mounted to the discharge end of the discharge adapter, the lid including a top wall, a generally cylindrical flange extending generally perpendicularly from the top wall toward the bag and an inner cylinder extending generally perpendicularly from the top wall toward the bag, the cylindrical flange and the inner cylinder defining a debris deflection area.

8. The lawn vacuum of claim 7 wherein the cylindrical flange and inner cylinder of the lid are mounted coaxially on a central axis of the lid.

9. The lawn vacuum of claim 1 wherein the lid is constructed of a generally rigid polymeric material.

10. The lawn vacuum of claim 1 wherein the tube is flexible to permit the nozzle to move relative to the frame.

11. The lawn vacuum of claim 1 wherein the debris from the ground surface is drawn into the lawn vacuum through the nozzle, flows through the tube, past the impeller, through the discharge adapter and into the bag assembly where the debris is deposited into the bag.

12. The lawn vacuum of claim 11 wherein air that is drawn into the bag assembly along with the debris flows out of the bag assembly through a gap between the bag and the sleeve and out of the second mouth.

13. The lawn vacuum of claim 1 further comprising:
a handle mounted to the frame that permits a user to direct movements of the lawn vacuum during operation, the handle being positioned proximate at least portions of a periphery of the lid such that the user is located proximate a side surface of the sleeve during operation, the lid and sleeve generally preventing debris and forced air discharged from the impeller from impacting the user.

14. A lawn vacuum for removing debris from a ground surface and storing the debris for disposal, the lawn vacuum comprising:
a frame;
a nozzle mounted to the frame, the nozzle defining an inlet;
an impeller mounted to the frame for creating a vacuum pressure at the inlet to draw debris into the inlet; and
a bag assembly including a lid and a container in communication with the impeller, the lid including a top wall, a generally cylindrical flange and an inner cylinder, the flange and inner cylinder defining a debris deflection area for deflecting debris drawn into the container by the impeller.

15. The lawn vacuum of claim 14 wherein the container is comprised of a bag and an air impervious sleeve.

16. The lawn vacuum of claim 15 wherein the sleeve includes a first mouth and the bag includes a top end, the top end being secured to the first mouth.

17. The lawn vacuum of claim 16 wherein the top end is secured to the first mouth at a seam that is constructed of stitching.

18. The lawn vacuum of claim 14 wherein the cylindrical flange and inner cylinder are mounted coaxially on a central axis of the lid.

19. The lawn vacuum of claim 14 wherein the inner cylinder includes an external surface and the flange and top wall include inner surfaces, the external surface and inner surfaces being general resistant to impacts from debris entering the bag assembly through the discharge end.

20. The lawn vacuum of claim 14 wherein the nozzle is pivotally mounted to the frame, the nozzle including nozzle wheels and curved ends such that the nozzle is navigable over debris in the path of the lawn vacuum.
